(19) United States
(12) Patent Application Publication
(10) Pub. No.: US 2014/0034698 A1
(43) Pub. Date: Feb. 6, 2014

(54) Sign Caddy

(71) Applicant: Larry Cooper, Statham, GA (US)

(72) Inventor: Larry Cooper, Statham, GA (US)

(21) Appl. No.: 13/955,253

(22) Filed: Jul. 31, 2013

Related U.S. Application Data
(60) Provisional application No. 61/677,549, filed on Jul. 31, 2012.

(51) Int. Cl. B60R 9/06

(52) U.S. Cl. CPC B60R 9/06
USPC 224/519

(57) ABSTRACT

Disclosed is a sign caddy system for mounting from a hitch receiver of a vehicle. Certain embodiments include a pair of upright tube arrays that are spaced apart such that a tube in one array can receive a first leg of a sign (such as a real estate listing sign) while a complimentary tube in the other array receives a second leg of the sign. Advantageously, users of a sign caddy embodiment can easily transport real estate signs (or other sign types) externally on the vehicle.

### CROSS-REFERENCE TO RELATED APPLICATIONS

Priority under 35 U.S.C. §119(e) is claimed to the U.S. provisional application entitled “SIGN CADDY,” filed on Jul. 31, 2012 and assigned application Ser. No. 61/677,549, the entire contents of which are hereby incorporated by reference.

### BACKGROUND

The present invention relates to equipment transport systems and, more particularly, to a caddy system for organizing and transporting real estate listing signs. Real estate agents and brokers commonly place signs on properties listed for sale, the signs serving to catch the attention of the buying public. Signs are reused from one property to the next and, as such, are often transported between properties in an agent's vehicle. It is also common for a real estate agent to store unused listing signs in a vehicle until needed.

Typical listing signs known in the art are made of metal and have two legs operable to serve as stakes in the ground, thereby providing a means for firmly positioning the listing signs in an upright position. Not surprisingly, being stuck in the ground and left out in the elements, the listing signs can become rusty, muddy and generally less than pristine. Additionally, because the purpose of listing signs is to catch the attention of the passing public, they are usually relatively large and cumbersome. Rusty metal listing signs with muddy stakes as legs are not friendly to the interior of a vehicle and, when stacked in a vehicle, tend to make a lot of racket. Therefore, what is needed in the art is a caddy system suitable to organize real estate listing signs and transport the signs on the outside of a vehicle.

### BRIEF DESCRIPTION OF THE SEVERAL VIEWS OF THE DRAWING

FIG. 1 is a perspective view of an embodiment of a sign caddy, shown with a typical real estate listing sign received into a pair of complimentary upright tubes;

FIGS. 2A-2B illustrate exploded and perspective views of the FIG. 1 embodiment;

FIG. 3A illustrates the FIG. 1 embodiment mounted on a vehicle;

FIG. 3B illustrates an exemplary embodiment of a sign caddy with an integrated license tag feature;

FIG. 3C is a perspective view of the sign caddy embodiment of FIG. 3B;

FIG. 4 is a perspective and detailed view of an adjustable embodiment of a sign caddy;

FIG. 5 is a side view of a “break away” aspect that may be included in some embodiments of a sign caddy; and

FIG. 6 is a perspective view of a sign caddy embodiment shown with left and right tube arrays comprising three tubes each.

### BRIEF SUMMARY OF THE INVENTION

Various embodiments, aspects and features of the present invention encompass a caddy system configured to be anchored to the exterior of a vehicle for transporting real estate listing signs. An exemplary embodiment includes a cross-bar support member mechanically fixed to a drawbar. As is understood in the art, the drawbar may be inserted into a receiver hitch mounted off the bumper or the undercarriage of a vehicle. Once inserted into the receiver hitch, the cross-bar may be positioned substantially parallel to the bumper of the vehicle. At either end of the cross-bar member, a series of upright tubes may be mounted to the cross-bar and/or each other in an array such that the array roughly parallels the drawbar element. Advantageously, the arrays of upright tubes on either end of the cross-bar element may be fixed in position, or adjustable, relative to each other such that two legs of a real estate listing sign can be simultaneously inserted into complimentary tubes of each array.

Embodiments of a sign caddy are not limited to the exemplary aspects and features described above. Certain embodiments may include additional features, or different features, while other embodiments include alternative features. As a way of example, and not limitation, it is envisioned that some embodiments of a sign caddy may be configured to mount to a pintle hook mounting plate, a gooseneck hitch, or any support structure, removable or fixed, that is suitable for receiving a sign caddy system on the outside of a vehicle. Moreover, while some embodiments of a sign caddy may be constructed of powder coated carbon steel, embodiments of a sign caddy are not limited by materials of construction as it is envisioned that a sign caddy may be constructed from any suitable material or combination of materials including, but not limited to, aluminum, aluminum alloy, stainless steel, poly vinyl chloride (“PVC”), etc.

### DESCRIPTION

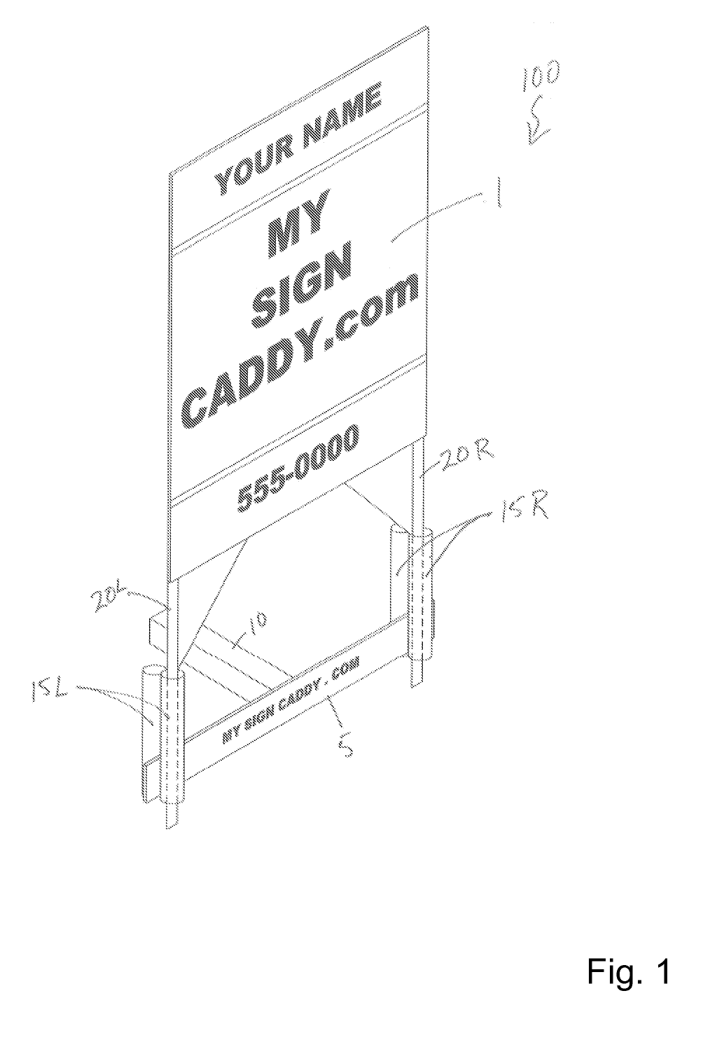

FIG. 1 is a perspective view of an embodiment of a sign caddy 100, shown with a typical real estate listing sign 1 received into a pair of complimentary upright tubes from tube arrays 15L and 15R. Notably, the tube arrays 15L, 15R are spaced relatively to each other on the cross-bar 5 such that the legs 20L, 20R of the real estate listing sign 1 can be inserted into complimentary tubes. The drawbar 10 may be inserted into a receiver hitch (not shown) such that the sign caddy is securely attached to the vehicle, thereby providing a user with the ability to transport the real estate listing sign 1 on the exterior of the vehicle. Advantageously, as can be seen in the FIG. 0 illustration, certain embodiments of a sign caddy may be configured such that advertisements or other data may be displayed on the cross-bar component. Also, it is an advantage of certain sign caddy embodiments that real estate listing signs 1 may be positioned such that data listed on the sign 1 is prominently displayed.

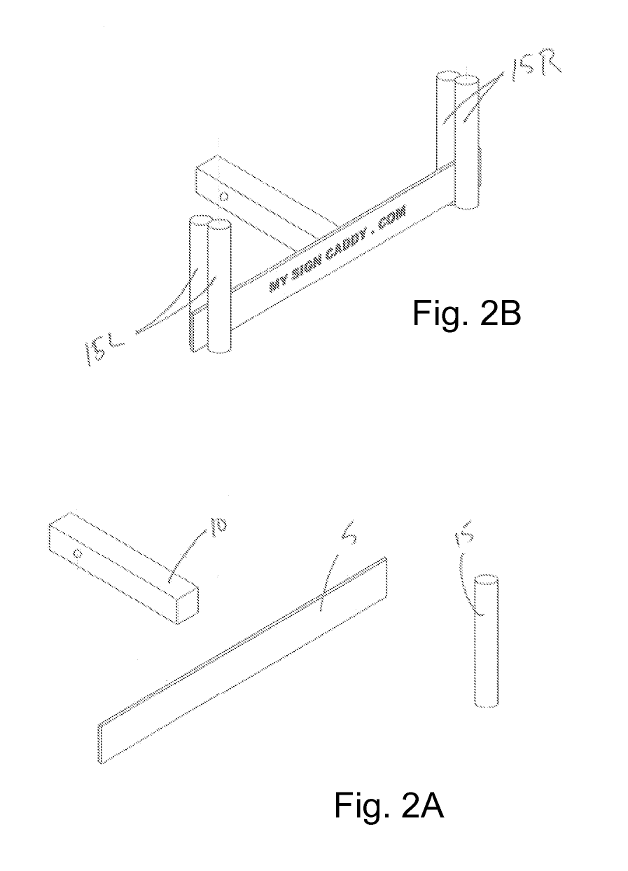

FIG. 2A is an exploded view of the FIG. 1 embodiment. Notably, the FIG. 2A embodiment may be built to any suitable dimensions and, as such, a sign caddy will not be limited to the particular embodiment or dimensions that are optimal for an exemplary application described herein. The drawbar 10 in the FIG. 2A embodiment may include dimensions known in the art for receipt into a 1.25″ or 2″ receiver hitch. The upright tube 15 may be dimensioned at 9″ to 10″, although larger or smaller tube lengths are envisioned for different sign sizes. Moreover, although upright tube 15 is depicted with a circular cross-section, it is envisioned that other embodiments of a sign caddy may include upright tubes with cross-sectional geometries other than a circle. For example, and not limitation, it is envisioned that some embodiments may include upright tubes with square cross-sections such as may be constructed from square channel. Other embodiments may have upright tubes that are not tubes at all—that is, the upright “tubes” may actually be open c-channels with the open channels of complimentary “tubes” in the arrays facing outward relative to the drawbar.

FIG. 2B is a perspective view of the FIG. 1. Advantageously, upright tube arrays 15L, 15R may be dimensioned apart at a distance useful for accommodating real estate listing signs with legs 19″ or 25″ or 29″ or 31″ or 37″ apart, although other dimensions are envisioned. Notably, one of ordinary skill in the art would recognize that certain embodiments of a sign caddy specifically intended for organization and transport of a real estate listing signs will exhibit spacing between the arrays that is consistent with the typical leg spacing of real estate listing signs (19″ or 25″ for residential property listing signs, and 29″ or 31″ or 37″ for commercial property listing signs, for example). Moreover, it is further envisioned that a given embodiment of a sign caddy may include left and right tube arrays that provide for different distances between complimentary tubes such that signs of varying sizes could be accommodated by the single sign caddy system. Additionally, depending on the application, it is envisioned that the diameter of tubes in tube arrays of a sign caddy may vary and, as such, the particular cross-section or size of a tube will not limit the scope of this description.

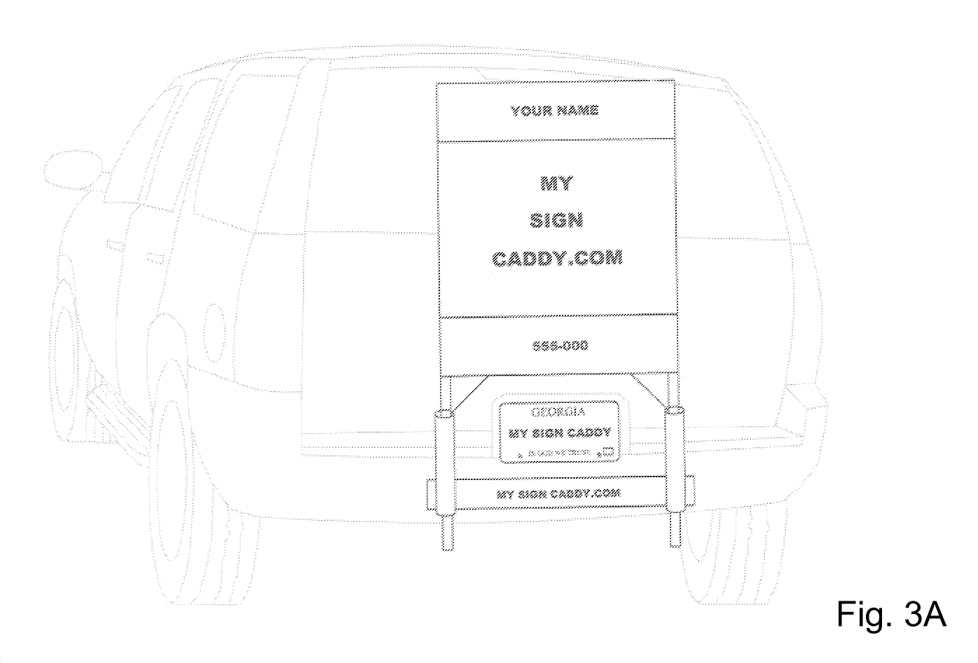

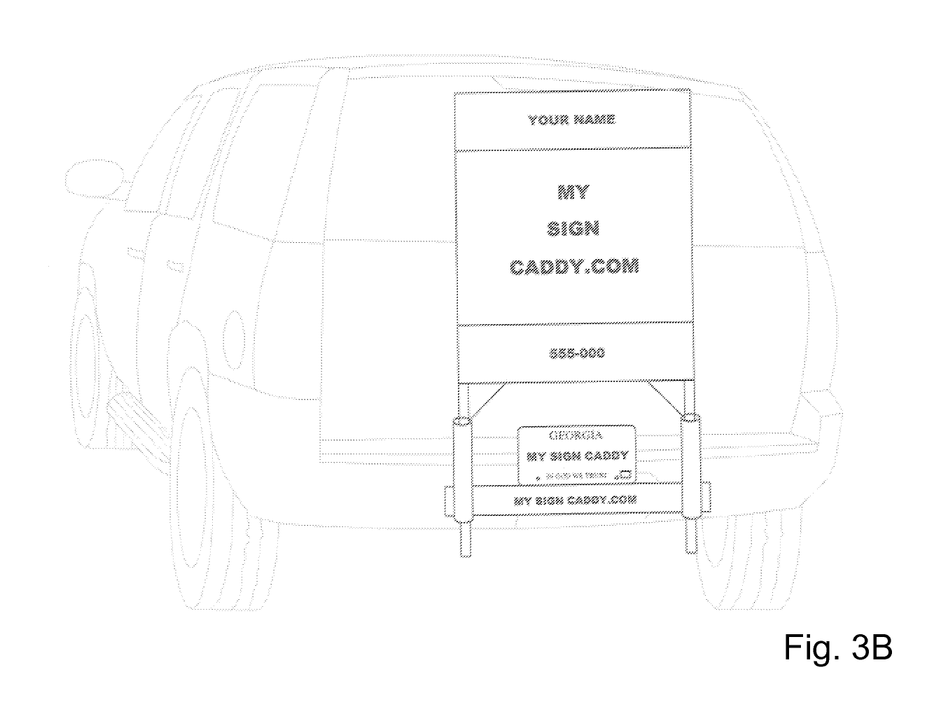

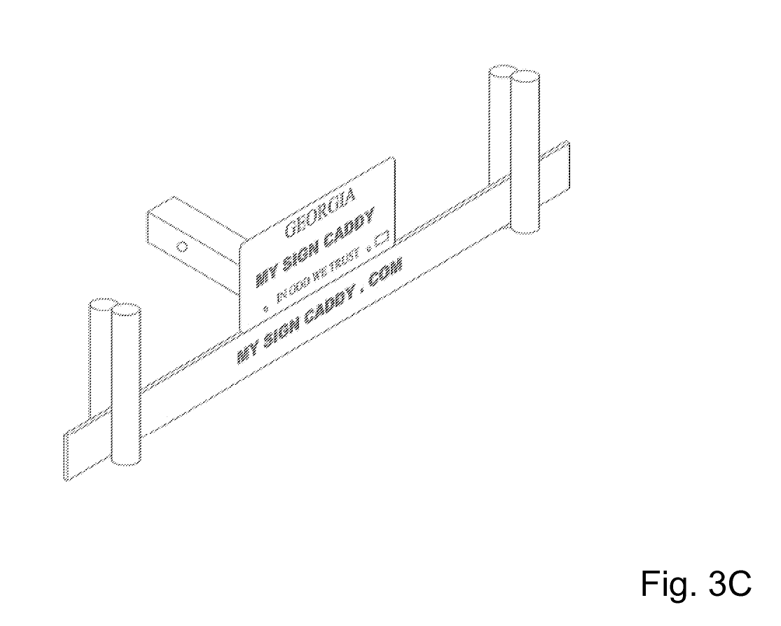

FIG. 3A is a front view of the FIG. 0 embodiment shown mounted to the rear of a vehicle. Notably, as can be seen in the FIG. 3A illustration, some embodiments of a sign caddy may include upright tubes dimensioned in height such that the real estate listing sign does not obstruct the view to the vehicle license tag.

FIG. 3B is a front view of a sign caddy embodiment shown mounted to the rear of a vehicle. Notably, as can be seen in the FIG. 3B illustration, some embodiments of a sign caddy may include upright tubes dimensioned in height such that the real estate listing sign does not obstruct the view to a vehicle license tag, or vanity tag, mounted to the cross-bar element.

FIG. 3C is a perspective view of the FIG. 3B embodiment.

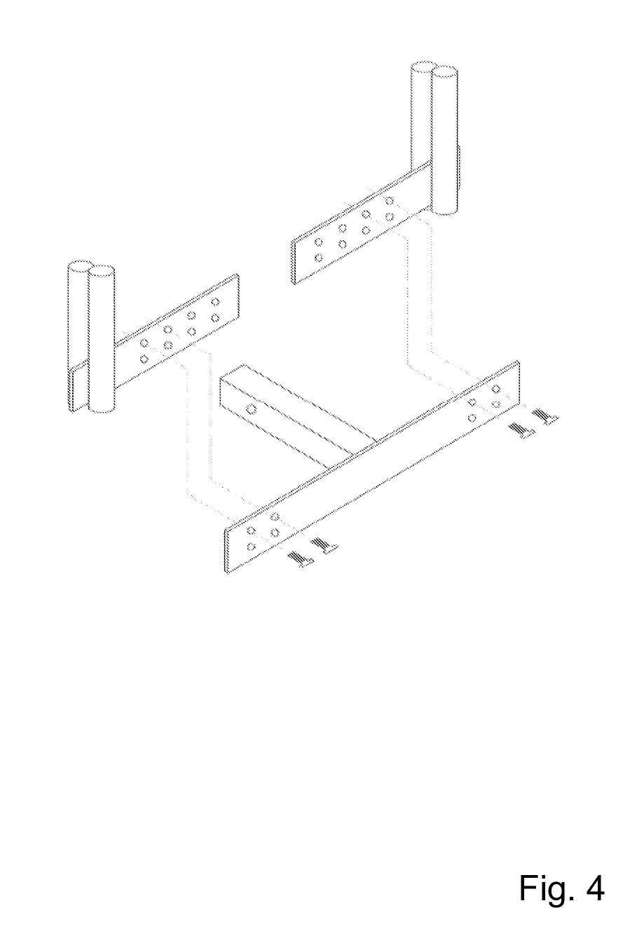

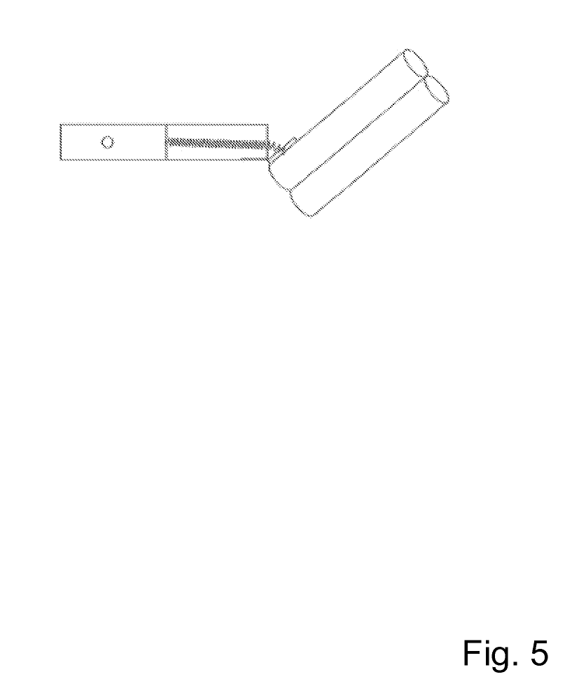

FIG. 4 is a perspective and detailed view of an adjustable embodiment of a sign caddy. In the FIG. 5 illustration, the exemplary adjustable sign caddy includes left and right tube arrays that may be mechanically fixed on left and right cross-bar elements, respectively. Each of the left and right cross-bar elements further include a series of through holes for position adjustment along a main cross-bar element. The through holes in the left and right cross-bar elements may be aligned with through holes on the main cross-bar element to effectively adjust the spacing between the upright tube arrays.

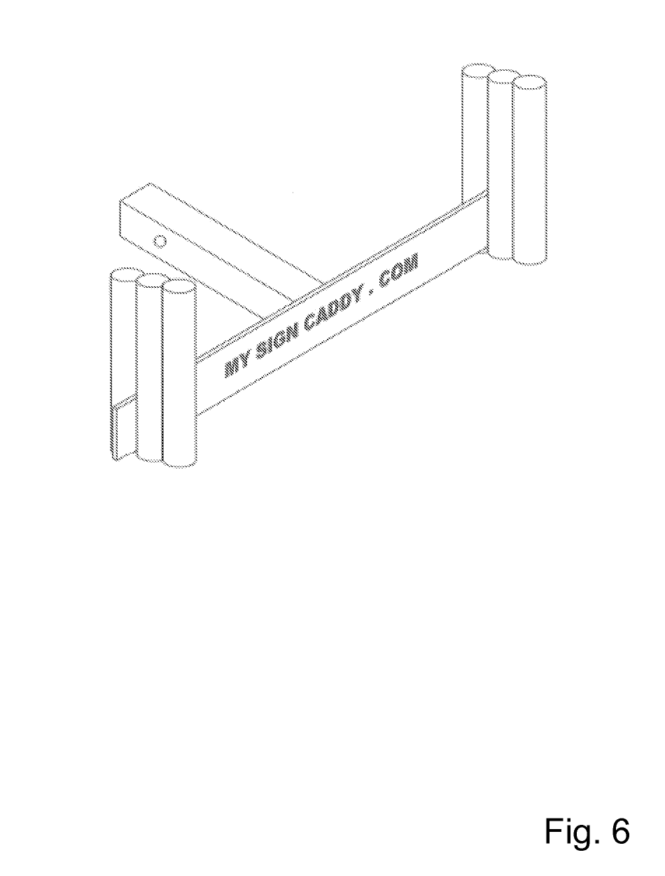

FIG. 5 is a side view of a “break away” aspect that may be included in some embodiments of a sign caddy. As can be seen in the FIG. 6 illustration, a spring mechanism and/or hinge may be anchored in the drawbar such that the cross-bar and tube array combination may be translated from an upright position to a position away from the vehicle. Advantageously, embodiments that include a break away feature may provide for easy access to rear compartments of the vehicle without having to remove the sign caddy from the vehicle. For example, rear window hatches or trunks may be opened and closed without interference with the sign caddy or real estate listing signs.

FIG. 6 is a perspective view of an embodiment of a sign caddy shown with left and right tube arrays comprising three tubes each. Notably, the FIG. 6 embodiment is provided for illustrative purposes only and is not meant to suggest that embodiments of a sign caddy are limited to include tube arrays with just 2 or 3 upright tubes. It is envisioned that embodiments of a sign caddy may include any number of upright tubes or other mechanisms for receipt of real estate signs that may be useful in the art. Notably, the FIG. 6 embodiment features signage on the cross-bar component.

What is claimed is:

1. A sign caddy system for organizing and transporting real estate listing signs, the sign caddy system comprising:
a drawbar configured to be received into a hitch receiver of a vehicle;
a cross-bar mounted to an end of the drawbar and substantially perpendicular to the drawbar; and
a pair of upright tube arrays mounted respectively to the distal ends of the cross-bar, wherein the tube arrays are spaced relative to each other such that complimentary tubes in the arrays are operable to simultaneously receive a leg of a sign.

2. The sign caddy system of claim 1, wherein the drawbar is configured to be received into a 1.25″ hitch receiver.

3. The sign caddy system of claim 1, wherein the drawbar is configured to be received into a 2″ hitch receiver.

4. The sign caddy system of claim 1, wherein one or more tubes in the tube arrays comprise a circular cross-section.

5. The sign caddy system of claim 1, wherein one or more tubes in the tube arrays comprise a square cross-section.

6. The sign caddy system of claim 1, wherein one or more tubes in the tube arrays comprise a c-shaped cross-section.

7. The sign caddy system of claim 1, wherein the tube arrays are 19″ apart.

8. The sign caddy system of claim 1, wherein the tube arrays are 25″ apart.

9. The sign caddy system of claim 1, wherein the tube arrays are 29″ apart.

10. The sign caddy system of claim 1, wherein the tube arrays are 31″ apart.

11. The sign caddy system of claim 1, wherein the tube arrays are 37″ apart.

12. The sign caddy system of claim 1, wherein two or more pairs of complimentary tubes in the tube arrays differ in the distance apart.
